(19) United States
(12) Patent Application Publication
(10) Pub. No.: US 2024/0182719 A1
(43) Pub. Date: Jun. 6, 2024

(54) EMULSIONS CONTAINING FUMED SILICA

(71) Applicant: Heritage Research Group, LLC, Indianapolis, IN (US)

(72) Inventors: Douglas Kriech, Indianapolis, IN (US); Anthony J. Kriech, Indianapolis, IN (US)

(73) Assignee: Heritage Research Group, LLC, Indianapolis, IN (US)

(21) Appl. No.: 18/441,017

(22) Filed: Feb. 14, 2024

Related U.S. Application Data
(63) Continuation of application No. PCT/US2022/040538, filed on Aug. 17, 2022.
(60) Provisional application No. 63/264,689, filed on Nov. 30, 2021.
(60) Provisional application No. 63/260,397, filed on Aug. 19, 2021.

(51) Int. Cl. C08L 95/00; C08K 3/36

(52) U.S. Cl. CPC C08L 95/005; C08K 3/36; C08L 2555/50

(57) ABSTRACT

Compositions containing fumed silica are disclosed herein, including emulsions and/or suspensions containing fumed silica and/or asphalt. In some embodiments, stable fumed silica suspensions can be prepared by adding a density modifier to the fumed silica and water.

### CROSS-REFERENCE TO RELATED APPLICATIONS

This application is a continuation of International Application No. PCT/US2022/040538 filed Aug. 17, 2022, the entirety of which is hereby incorporated by reference in its entirety. International Application No. PCT/US2022/040538 claims the right of priority to U.S. Provisional Patent Application No. 63/260,397 filed on Aug. 19, 2021 and 63/264,689 filed on Nov. 30, 2021, the entireties each of which are hereby incorporated by reference herein in their entirety.

### BACKGROUND

Work with fumed silica in asphalt was previously disclosed in U.S. Pat. No. 9,732,478 for a void reducing membrane for pavement joints. The benefit of fumed silica is that it makes the asphalt binder less tracking from construction and motoring traffic immediately after hot application until it is covered with Hot Mix Asphalt (HMA) at the longitudinal joints. A second feature of asphalt binder and fumed silica mixtures is added high temperature stiffness. The dynamic shear rheometer tests show that a 1.5-2% addition to asphalt binder will raise the high temperature asphalt binder stiffness by 10° C. without adversely affecting the low temperature properties of the asphalt binder.

Although these hot applications have been found effective for joint treatments for void filling as well as for hot-spray applications for reducing tracking in tack coat bonding applications between lifts of hot mix, there is a desire to find ways to lower temperature of application. Typically, in the asphalt industry the way that application temperatures can be lowered is through asphalt emulsification with soap and water, thereby producing a stable colloidal suspension. The advantage of emulsifying asphalt is conventional asphalt distributors and application equipment can be used at 25-90° ° C. rather than 150-200° C. for hot asphalt applications. This includes applications for spraying such as tack coats, chip seals, and fog seals, as well as crack filling roads through a distributor with a hand wand. Asphalt emulsions have lower energy production costs and reduced storage and application temperature which reduce the Life Cycle Assessments (LCA) footprints. Worker safety would also be improved with lower temperature application from the standpoint of emissions from fumes and the risk of severe burns in handling and application of the product. Accordingly, there remains a need to find methods of emulsifying fumed silica, which may be used as the basis for preparing asphalt-based emulsions.

### BRIEF DESCRIPTIONS OF THE DRAWINGS

FIG. 1 shows an exemplary stabilization curve illustrating the density change to fumed silica based on an increase of weight of density modifier (STR) (based on grams of STR per 1 gram of fumed silica (F.S.)).

FIG. 2 shows a graph of the pourable limit of compositions plotted by the weight of fumed silica (“wt/wt F.S.”) as a function of the pH of the starting sodium hydroxide solution.

### DETAILED DESCRIPTION

Taking the advantages that fumed silica provides in certain applications, including asphalt applications, and finding a way to produce stable emulsions and suspensions containing fumed silica was the purpose of the development of the inventions described herein.

The challenge with making a stable colloidal suspension of fumed silica-based emulsions is that fumed silica is hydrophobic in water. Attempts to stabilize a colloidal suspension result in rapid phase separation. For example, adding fumed silica into the asphalt binder first, and then attempting emulsification, has two challenges. The first is the added rheological stiffness of the asphalt binder and fumed silica mixture, which makes shearing more difficult in the colloid mill. Secondly, the fumed silica is highly abrasive to the metal parts of the shear, causing excessive wear in the mill. Additionally, attempts to post-add the fumed silica into the asphalt emulsion with mixing leads to an immediate phase separation of the asphalt emulsion and fumed silica in application.

In certain embodiments, to overcome the hydrophobicity of fumed silica in water, the pH of the water phase was increased to passivate the surface of the silica. In some embodiments, at pH of 9 and higher with simple shear with a mixing blade, a stable suspension was created with up to 30% fumed silica in water by weight. In certain embodiments, this white stable suspension can then be post-added to a variety of emulsions (e.g., anionic asphalt emulsion or nonionic or cationic slow set emulsion) without destabilizing the emulsion, whether through pH shift or silica sensitivity tests. In some embodiments, the resulting colloidal mixture can then be applied like any other asphalt emulsion through spray or wand applications. Testing on tack coat, chip seal and crack filling applications show that once the water is released the asphalt residue is non-tracking and having good high temperature stiffness.

In some embodiments, stable fumed silica suspensions can be prepared by adding a density modifier to the fumed silica and water. For example, in some embodiments the fumed silica exhibits a density of about 0.85 g/ml or less, resulting in the fumed silica rapidly separating from the water and floating to the top. However, in certain embodiments it has been surprisingly discovered that altering the density of the fumed silica to bring it closer to the density of water (1 mg/ml) can be effective in creating stable suspensions.

In certain embodiments, the density of the fumed silica is enhanced by the density modifier to greater than about 0.85 mg/ml, such as about 0.90 mg/ml or greater, 0.92 mg/ml or greater, 0.95 mg/ml or greater, 0.98 mg/ml or greater, 1.00 mg/ml or greater, or even 1.02 mg/ml or greater. In some embodiments, the enhanced fumed silica exhibits a density of about 0.90 to about 1.10 mg/ml, such as about 0.95 to about 1.05 or about 0.98 to about 1.02 mg/ml. In some embodiments, the fumed silica exhibits a density of about 0.95, about 0.96, about 0.97, about 0.98, about 0.99, about 1.00, about 1.01, about 1.02, about 1.03, about 1.04 or even about 1.05 mg/ml.

In some embodiments, the fumed silica comprises a fumed silica in which the surface hydroxyl groups have been modified to alter the hydrophobic/hydrophilic properties of the material. In some embodiments, the fumed silica is modified with alkyl silane, such as halogenated alkyl silane. For example, in some embodiments the fumed silica is treated with an alkyl silyl material to provide fumed silica having one or more silyl ether residues (e.g., methyl silyl ether).

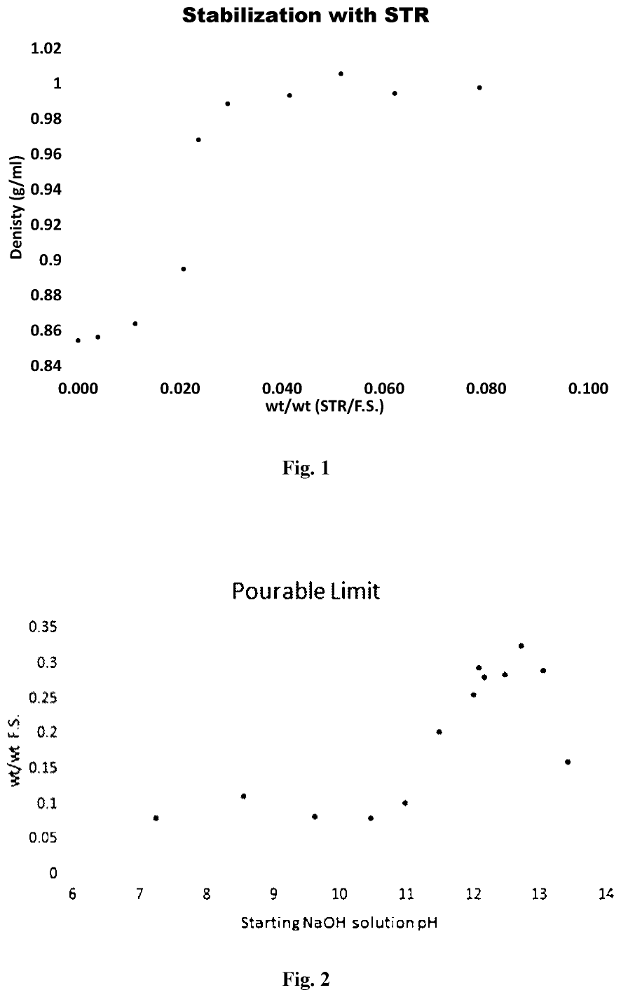

In some embodiments, the density modifier (also referred to as a “surface tension reducer” or “STR”) is used in a ratio that is necessary to achieve the desired suspension properties of the fumed silica. In some embodiments, the wt:wt ratio of density modifier:fumed silica is about 1:10 to about 1:75, such as about 1:15 to about 1:50 or about 1:20 to about 1:40. An exemplary stabilization curve showing density of the fumed silica to weight of density modifier (STR grams per 1 gram of fumed silica (F.S.)) are shown in FIG. 1.

In some embodiments, the density modifier is selected from anionic and/or nonionic surface tension reducers. Exemplary density modifiers include, but are not limited to, polymeric surfactants (polymeric alkoxylates, such as polymeric ethoxylates) and mixed stream surfactants (ethoxysulfates, sulfates, sulfonates and carboxylates). Non-limiting examples of polymeric surfactants include Redicote® E-95 (available from AkzoNobel), TRITON™ X-100, TERGITOL™, TRITON™ RW-50 and ECOSURT™ EH-9 (all available from Dow Chemical), and LUTENSOL® XL 80, LUTENSOL® XP 80, and LUTENSOL® XP 90 (available from BASF). Non-limiting examples of mixed stream surfactants include BIO SOFT® LD-95 (available from Stepan Company), Dawn 2× (available from Proctor & Gamble), Redicote® E-47 NPF (available from AkzoNobel), Palmolive 11119 and Palmolive 11118 (available from Colgate-Palmolive Company).

FIG. 2 shows a graph of the pourable limit of compositions plotted by the weight of fumed silica (“wt/wt F.S.”) as a function of the pH of the starting sodium hydroxide solution.

### Example 1

### Preparation of Fumed Silica/Asphalt Crack Filler Emulsion

A composition of a caustic (NaOH) was added to water in an IBC tote until the pH of the solution was about 12.5. Fumed silica was then added to provide a suspension of about 30% TS-610 fumed silica. A pump was connected to an outlet of the IBC tote, and a hose was attached to the outlet of the pump placed in the top of the IBC tote for recirculation. A top-down tote mixer was placed in the total and the solution left to mix for about 12 hours to blend the fumed silica into the composition to provide a fumed silica composition.

Next, 0.07 gallons of the 30% fumed silica suspension is added per gallon of a pre-existing asphalt emulsion comprising water, petroleum asphalt/bitumen, and an emulsifier. The solution was then mixed to provide a fumed silica asphalt emulsion for use as a crack filler. The fumed silica asphalt emulsion was then applied to the surface of a pre-existing asphalt pavement for purposes of crack filling. Evaporation of the water resulted in a crack filler asphalt residue comprising about 2 wt. % fumed silica.

### Example 2

### Stabilized Fumed Silica Suspension and Asphaltic Emulsion

A 5% wt/wt stabilized fumed silica solution was prepared by weighing 100 g of a 30% wt/wt fumed silica suspension (prepared according to the method set forth above in the first step of Example 1) and diluting with 500 ml of water. To this, 0.6 g of Redicote® E-95 was added and the entire mixture was stirred for 24 hours to allow the surface tension reducer to fully disperse to form the fumed silica suspension.

An anionic emulsion with 67% asphalt solids was modified with fumed silica, such that 100 g of 30% wt/wt fumed silica suspension prepared in step 1 was added to 850 g of the anionic emulsion. To this, 0.6 g of Redicote® E-95 was added, and the mixture was allowed to stir at 60° C. for 24 hours. The resulting broken emulsion consisted of approximately 5% fumed silica suspended in approximately 95% asphalt.

### ADDITIONAL EMBODIMENTS

In some embodiments, a rapid, medium, and slow anionic emulsion were prepared. In further embodiments, a cationic or a nonionic slow setting emulsion was prepared.

In one embodiment, a composition with a pH of 12.5 was used as a starting solution by dissolving 1.6 g of NaOH per liter or 4.6 g NaOH per gallon. In some embodiments, the pH of the composition may have a pH of at least 9, a pH of at least 10, a pH of at least 11, or a pH of at least 12.5.

In some embodiments, a target 30% by weight suspension would utilize 596 g of TS-610 fumed silica per liter of base solution, or about 5 lbs. TS-610 fumed silica per gallon of base solution.

In some embodiments, fumed silica may be modified. For example, in one embodiment, fumed silica may be treated with trimethylchlorosilane prior to being used in an emulsion. In one embodiment, the fumed silica used in compositions may comprise CAB-O-SIL® TS-610.

Fumed silica may be suspended within water in compositions of the present disclosure.

In some embodiments, fumed silica compositions of the present disclosure comprise an alkaline pH. In some embodiments, fumed silica compositions of the present disclosure may have an alkaline pH. In some embodiments, the pH of the fumed silica compositions may have a pH greater than 9, pH greater than 10, pH greater than 11, or a pH greater than 12.

In some embodiments, pH can be adjusted to overcome the hydrophobicity of fumed silica in water. Without being bound to a particularly theory, a high pH may be used to passivate the surface of fumed silica. For example, at a pH of 10 and higher a stable suspension was created with up to 30% fumed silica in water by weight using simple mixing with a mixing blade. In some embodiments, shear mixing (e.g., such as a lab blender) may be applied to provide a more stable suspension/solution. This white stable suspension can then be post added to any anionic emulsion or any nonionic or cationic slow set emulsion without destabilizing the emulsion whether through pH shift or silica sensitivity tests.

The uses of the terms “a” and “an” and “the” and similar references in the context of describing the invention (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only some of the embodiments have been shown and described and that all changes and modifications that come within the spirit of the invention are desired to be protected. In addition, all references cited herein are indicative of the level of skill in the art and are hereby incorporated by reference herein in their entirety.

### EMBODIMENTS

The following provides an enumerated listing of some of the embodiments disclosed herein. It will be understood that this listing is non-limiting, and that individual features or combinations of features (e.g. 2, 3 or 4 features) as described in the Detailed Description above can be incorporated with the below-listed Embodiments to provide additional disclosed embodiments herein.
1. A composition comprising:
   water;
   fumed silica having a density of greater than 0.85 mg/ml; and
   a density modifier.
2. The composition of embodiment 1, wherein the fumed silica has a density of about 0.95 to about 1.1 mg/ml.
3. The composition according to any one of the preceding embodiments, wherein the density modifier comprises a polymeric surfactant.
4. The composition of embodiment 3, wherein density modifier comprises a polymeric alkoxylate.
5. The composition of embodiment 3, wherein the density modifier comprises a polymeric ethoxylate.
6. The composition of any one of the preceding embodiments, wherein fumed silica comprises a modified fumed silica.
7. The composition of embodiment 6, wherein the fumed silica comprises one or more silyl ether residues.
8. The composition according to any one of the preceding embodiments, wherein the composition further comprises at least one asphaltic material.
9. The composition of embodiment 8, wherein the asphaltic material comprises at least one asphalt binder.
10. The composition according to any one of the preceding embodiments, further comprising a caustic material.
11. The composition according to any one of the preceding embodiments, wherein the caustic comprises sodium hydroxide.
12. The composition according to any one of the preceding embodiments, wherein the composition exhibits a pH of at least 9.
13. A method of preparing a water-containing asphaltic material, comprising:
   selecting an asphalt emulsion; and
   adding an aqueous suspension of fumed silica to the asphalt emulsion to provide a modified asphalt emulsion.
14. The method of embodiment 13, wherein the aqueous suspension comprises a composition according to any one of claims 1-12.
15. The method of any one of embodiments 13-14, wherein the asphalt emulsion is slow set.
16. The method of any one of embodiments 13-15, wherein the aqueous suspension has a pH of at least 9.
17. The method of any one of embodiments 13-16, wherein the asphalt emulsion comprises an asphalt binder.
18. The method of any one of embodiments 13-17, wherein the asphalt emulsion comprises at least one emulsifier.

1. A composition comprising:
water;
fumed silica having a density of greater than 0.85 mg/ml; and
a density modifier.

2. The composition of claim 1, wherein the fumed silica has a density of about 0.95 to about 1.1 mg/ml.

3. The composition according to claim 1, wherein the density modifier comprises a polymeric surfactant.

4. The composition of claim 3, wherein density modifier comprises a polymeric alkoxylate.

5. The composition of claim 3, wherein the density modifier comprises a polymeric ethoxylate.

6. The composition of claim 1, wherein fumed silica comprises a modified fumed silica.

7. The composition of claim 6, wherein the fumed silica comprises one or more silyl ether residues.

8. The composition according to claim 1, wherein the composition further comprises at least one asphaltic material.

9. The composition of claim 8, wherein the asphaltic material comprises at least one asphalt binder.

10. The composition according to claim 1, further comprising a caustic material.

11. The composition according to claim 10, wherein the caustic comprises sodium hydroxide.

12. The composition according to claim 1, wherein the composition exhibits a pH of at least 9.

13. A method of preparing a water-containing asphaltic material, comprising:
selecting an asphalt emulsion; and
adding an aqueous suspension of fumed silica to the asphalt emulsion to provide a modified asphalt emulsion.

14. The method of claim 13, wherein the aqueous suspension comprises a composition according to claim 1.

15. The method of claim 13, wherein the asphalt emulsion is slow set.

16. The method of claim 13, wherein the aqueous suspension has a pH of at least 9.

17. The method of claim 13, wherein the asphalt emulsion comprises an asphalt binder.

18. The method of claim 13, wherein the asphalt emulsion comprises at least one emulsifier.
